(19) United States
(12) Patent Application Publication
(10) Pub. No.: US 2021/0362589 A1
(43) Pub. Date: Nov. 25, 2021

(54) HYDROGEN TANK STORAGE CASE

(71) Applicant: TOYOTA JIDOSHA KABUSHIKI KAISHA, Toyota-shi (JP)

(72) Inventor: Masahiko MORINAGA, Toyota-shi (JP)

(21) Appl. No.: 17/241,166

(22) Filed: Apr. 27, 2021

(30) Foreign Application Priority Data
May 25, 2020 (JP) 2020-090495

(51) Int. Cl. B60K 15/07; B60K 15/03

(52) U.S. Cl. CPC B60K 15/07; B60K 2015/03151; B60K 15/03006

(57) ABSTRACT

A hydrogen tank storage case that stores a hydrogen tank and that is loaded on a moving object includes: a housing having a box shape and having a side wall, a bottom, and a lid. The bottom and the lid have a communication portion configured to allow communication between the inside and outside of the housing. A flow resistance of the lid is lower than a flow resistance of the bottom.

### CROSS-REFERENCE TO RELATED APPLICATION

This application claims priority to Japanese Patent Application No. 2020-090495 filed on May 25, 2020, incorporated herein by reference in its entirety.

### BACKGROUND

### 1. Technical Field

The present disclosure relates to a case that stores a hydrogen tank.

### 2. Description of Related Art

High-pressure tanks for fuel cell vehicles store hydrogen therein, and it is important to take measures against leakage of hydrogen. In a hydrogen tank storage facility etc. installed on the land, damage from any leaked hydrogen can be reduced by providing a protective wall as in, e.g., Japanese Unexamined Patent Application Publication No. 2006-22506 (JP 2006-22506 A). However, especially when a moving object such as a vehicle is loaded with a hydrogen tank such as when a fuel cell vehicle is loaded with a hydrogen tank as a fuel tank or when the moving object is loaded with a plurality of hydrogen tanks in order to transport the hydrogen tanks, the hydrogen tank is stored in a storage case, but a protective wall cannot be provided. It is therefore necessary to take other measures against leakage of hydrogen.

More specifically, even when the storage case has a discharge hole(s), any hydrogen dispersed from the discharge hole(s) disperses in the horizontal direction with respect to the ground. Especially the leaked hydrogen dispersing in the horizontal direction is more likely to catch fire, and it therefore is necessary to avoid such dispersion of hydrogen in the horizontal direction. Accordingly, when hydrogen leaks inside the case, the leaked hydrogen needs to be quickly discharged to the outside of the vehicle such that hydrogen does not disperse in the horizontal direction.

Japanese Unexamined Patent Application Publication No. 2017-128202 (JP 2017-128202 A) discloses a work vehicle including a storage case storing a plurality of hydrogen tanks. The upper wall of this storage case has vents through which any leaked hydrogen is discharged to the outside of the work vehicle.

Japanese Unexamined Patent Application Publication No. 2005-116358 (JP 2005-116358 A) discloses a tank storage unit for a vehicle that stores a fuel tank. A discharge pipe extends from the lower portion of the tank storage unit to a void portion in an upper corner of the tank storage unit, namely to the clearance between the tank storage unit and the fuel tank in the upper corner of the tank storage unit. The discharge pipe is disposed with its discharge port facing upward.

### SUMMARY

JP 2017-128202 A and JP 2005-116358 A describe that any hydrogen leaking from the hydrogen tank can be discharged to the outside. However, it cannot be said that sufficient measures have been taken against dispersion of the leaked hydrogen in the horizontal direction. Moreover, it is desirable in terms of space and reliability to minimize the use of additional devices such as a discharge device.

The present disclosure provides a hydrogen tank storage case that can smoothly and safely discharge any leaked hydrogen.

The present disclosure is a hydrogen tank storage case that stores a hydrogen tank and that is loaded on a moving object. The hydrogen tank storage case includes a housing having a box shape and having a side wall, a bottom, and a lid. The bottom and the lid have a communication portion configured to allow communication between inside and outside of the housing. A flow resistance of the lid is lower than a flow resistance of the bottom.

At least one of the bottom and the lid may include a perforated metal, and the communication portion may be composed of a hole of the perforated metal.

The communication portion may be a slit.

At least one of the bottom and the lid may include a perforated metal and have a hole, and may further have a slit.

According to the present disclosure, the hydrogen tank storage case can smoothly and safely discharge any leaked hydrogen.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates the configuration of a moving object 1;

FIG. 2A is an external perspective view of a hydrogen tank storage case 20;

FIG. 2B is another external perspective view of the hydrogen tank storage case 20;

FIG. 3A is a sectional view of the hydrogen tank storage case 20;

FIG. 3B is another sectional view of the hydrogen tank storage case 20;

FIG. 4A is an external perspective view of a hydrogen tank storage case 30;

FIG. 4B is a sectional view of the hydrogen tank storage case 30;

FIG. 5A is a diagram illustrating the structure of a lid 34;

FIG. 5B is another diagram illustrating the structure of the lid 34;

FIG. 6 is a diagram illustrating another configuration of the lid 34;

FIG. 7A is a diagram illustrating the flow of leaked hydrogen;

FIG. 7B is another diagram illustrating the flow of leaked hydrogen;

FIG. 8A is a diagram illustrating dispersion of leaked hydrogen;

FIG. 8B is another diagram illustrating dispersion of leaked hydrogen;

FIG. 8C is still another diagram illustrating dispersion of leaked hydrogen;

FIG. 8D is yet another diagram illustrating dispersion of leaked hydrogen;

FIG. 9A is a further diagram illustrating dispersion of leaked hydrogen;

FIG. 9B is a still further diagram illustrating dispersion of leaked hydrogen; and

FIG. 9C is a yet further diagram illustrating dispersion of leaked hydrogen.

### DETAILED DESCRIPTION OF EMBODIMENTS

1. Moving Object

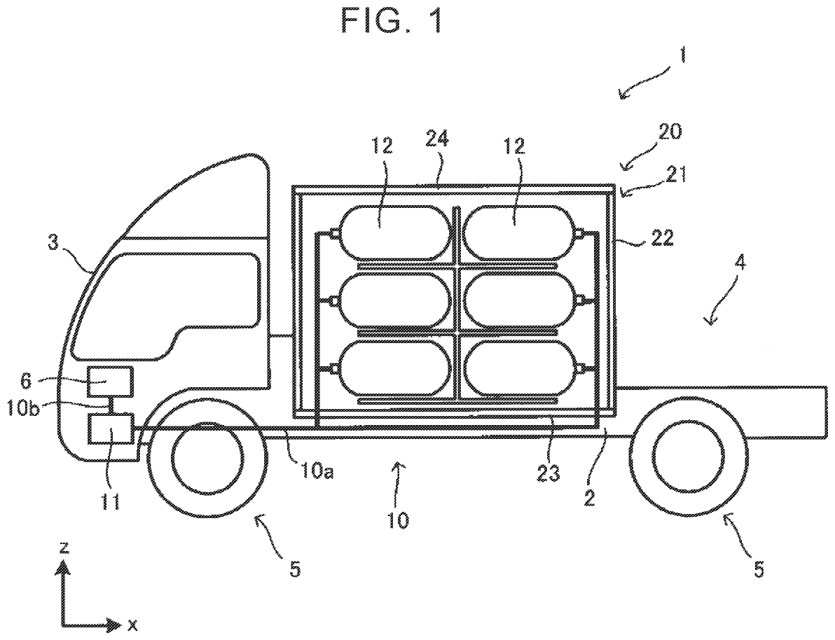

FIG. 1 schematically illustrates the structure of a moving object 1 loaded with a hydrogen tank storage case 20 according to a first form. The moving object 1 of this form is an automobile and includes a chassis 2, a driving portion 3 mounted on the front portion of the chassis 2, a bed portion 4 mounted on the rear portion of the chassis 2, wheel portions 5 attached to the lower portion of the chassis 2, an electric motor 6 that drives the automobile, and a fuel cell unit 10. In FIG. 1 and the subsequent drawings, the directions of a Cartesian coordinate system (x, y, z) are shown as necessary for better understanding. The fuel cell unit 10 includes a fuel cell 11, hydrogen tanks 12, air obtaining means, not shown, and the hydrogen tank storage case 20. Hydrogen is supplied from the hydrogen tanks 12 to the fuel cell 11 through a hydrogen supply pipe 10a and air is supplied from the air obtaining means, not shown, to the fuel cell 11. With this configuration electricity is generated by the fuel cell 11. The generated electricity is supplied to the electric motor 6 through an electrical wire 10b to drive the electric motor 6.

In such a moving object, the electric motor 6 is driven by a known method and can be driven by a commonly used method. A feature of the present disclosure is the hydrogen tank storage case 20 storing the hydrogen tanks 12. Accordingly, a specific form of the moving object is not particularly limited as long as it is a moving object loaded with a hydrogen tank storage case that will be described below, and various forms of the moving object are applicable. For example, the moving object of this form is a fuel cell vehicle that includes the hydrogen tanks 12 as fuel storage tanks for the fuel cell vehicle and includes the hydrogen tank storage case 20 storing the hydrogen tanks 12. However, the present disclosure is not limited to this, and the hydrogen tank storage case 20 may be a hydrogen tank storage case that is mounted on an automobile for merely transporting hydrogen tanks. The hydrogen tank storage case will be described.

2. Hydrogen Tank Storage Case

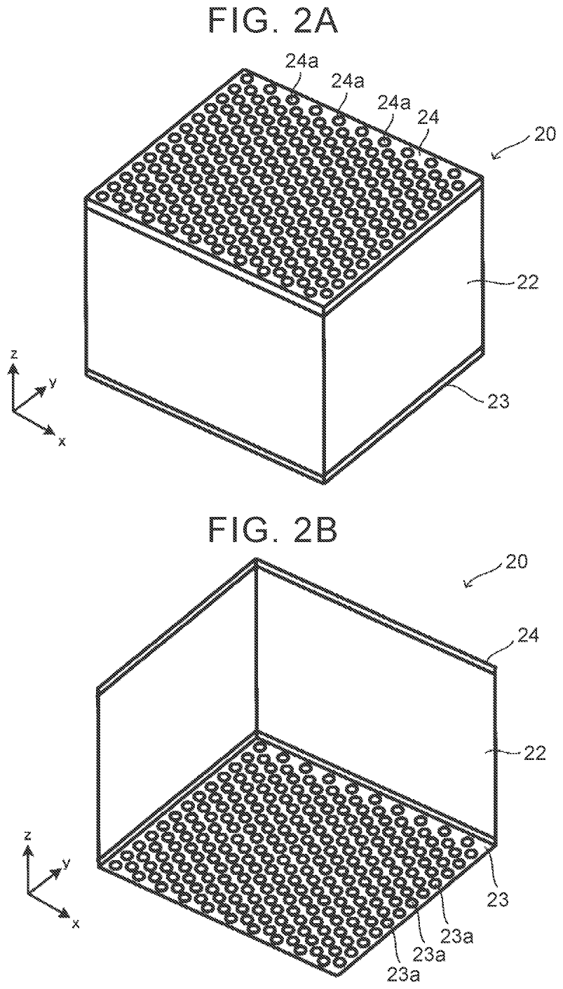

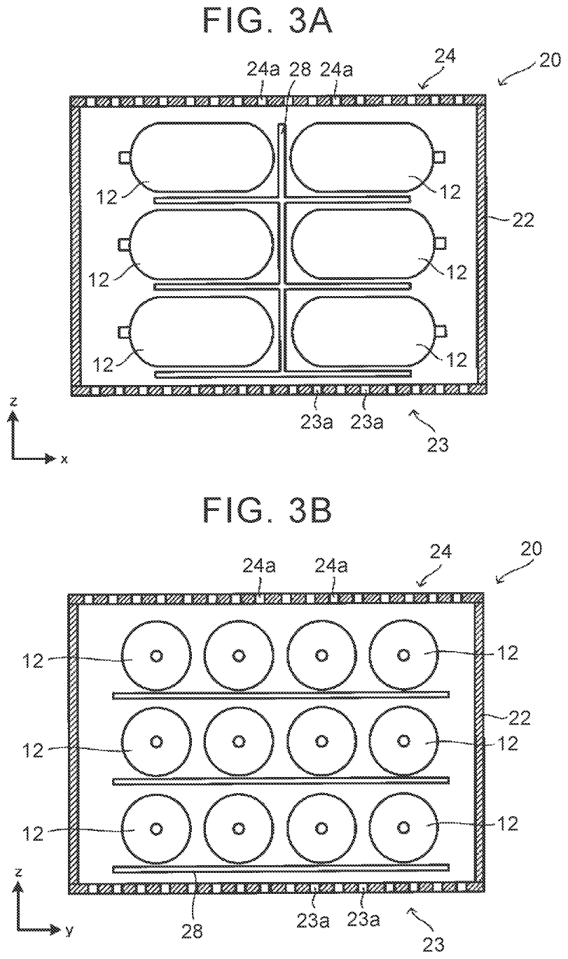

FIG. 2A is an external perspective view of the hydrogen tank storage case 20 in the first form as viewed from the lid 24 side, and FIG. 2B is an external perspective view of the hydrogen tank storage case 20 as viewed from the bottom 23 side. FIG. 3A is a sectional view of the hydrogen tank storage case 20 taken along a plane parallel to an xz plane, illustrating how the hydrogen tanks 12 are arranged in the hydrogen tank storage case 20. FIG. 3B is a sectional view of the hydrogen tank storage case 20 taken along a plane parallel to a yz plane, illustrating how the hydrogen tanks 12 are arranged in the hydrogen tank storage case 20. The hydrogen tank storage case 20 stores the hydrogen tanks 12 in this manner and is loaded on the moving object 1 as shown in FIG. 1. In this form, the hydrogen tank storage case 20 stores a total of 24 hydrogen tanks 12, two in the x direction, four in the y direction, and three in the z direction. In this form, the hydrogen tanks 12 are arranged such that bosses having a fusible plug therein face opposite directions in the x direction. The hydrogen supply pipe 10a is connected to the bosses of the hydrogen tanks 12, and hydrogen is supplied from the hydrogen tanks 12 to the fuel cell 11 through the hydrogen supply pipe 10a. The hydrogen tank storage case 20 of the first form includes a housing 21 and a tank support 28. Each configuration will be described.

2.1. Housing

The housing 21 is a box-shaped member that forms the outer shell of the hydrogen tank storage case 20, and the hydrogen tanks 12 and the tank support 28 are stored in the housing 21. In this form, the housing 21 has a side wall 22, a bottom 23, and a lid 24. In this form, the hydrogen tank storage case 20 is in the shape of a rectangular parallelepiped box. However, the shape of the hydrogen tank storage case is not limited to the rectangular parallelepiped and can be a cube, a cylinder, etc. The shape of the hydrogen tank storage case is not particularly limited as long as the hydrogen tank storage case can function as a housing.

Side Wall

The side wall 22 is a wall portion of the housing 21 that surrounds the hydrogen tanks 12 in the horizontal direction (direction parallel to the xy plane). In this form, it is preferable that the side wall 22 do not have an opening that allows communication between the inside and outside of the housing 21 and be configured such that no leaked hydrogen will flow out of the housing 21 through the side wall 22. This configuration prevents any hydrogen leaking inside the housing 21 from being directly discharged from the housing 21 with a driving force that drives the leaked hydrogen when the leaked hydrogen disperses in the horizontal direction. In this form, since the housing 21 is in the shape of a rectangular parallelepiped box, the side wall 22 forms the four sides other than the upper and lower sides of the housing 21.

Bottom

The bottom 23 is a member disposed so as to close the opening at the bottom of the space surrounded by the side wall 22. In this form, the bottom 23 is a member in the shape of a quadrangular plate. In this form, since the housing 21 is in the shape of a rectangular parallelepiped box, the bottom 23 forms the lower side of the housing 21.

The bottom 23 has a communication portion 23a that allows communication between the inside and outside of the housing 21. That is, the bottom 23 has the communication portion 23a such that gas can enter and leave the housing 21 through the bottom 23. Although the form of the communication portion 23a is not particularly limited, it is preferable that a plurality of communication portions be formed throughout the bottom 23. With this configuration, the communication portions are more evenly distributed in the bottom 23. Because the flow resistance to fluid passing through the lid 24 is lower than the flow resistance to fluid passing through the bottom 23 as described later, any hydrogen leaking from any of the hydrogen tanks 12 can be discharged with similar efficiency through the lid 24. Although a specific form of the communication portion is not particularly limited, the bottom 23 of this form is a plate having a plurality of holes formed throughout like a perforated metal, and the holes serve as the communication portions 23a. The communication portion 23a of the bottom 23 has a feature regarding the relationship with a communication portion 24a of the lid 24. This feature will be described later.

Lid

The lid 24 is a member disposed so as to close the opening at the top of the space surrounded by the side wall 22. In this form, the lid 24 is a member in the shape of a quadrangular plate. In this form, since the housing 21 is in the shape of a rectangular parallelepiped box, the lid 24 forms the upper side of the housing 21.

The lid 24 has a communication portion 24a that allows communication between the inside and outside of the housing 21. That is, the lid 24 has the communication portion 24a such that gas can enter and leave the housing 21 through the lid 24. Although the form of the communication portion 24a is not particularly limited, it is preferable that a plurality of communication portions be formed throughout the lid 24. With this configuration, the communication portions are more evenly distributed in the lid 24. Accordingly, any hydrogen leaking from any of the hydrogen tanks 12 is discharged with similar efficiency through the lid 24. Although a specific form of the communication portion is not particularly limited, the lid 24 of this form is a plate having a plurality of holes formed throughout like a perforated metal, and the holes serve as the communication portions 24a. The communication portion 24a of the lid 24 has a feature regarding the relationship with the communication portion 23a of the bottom 23. These communication portions will be described.

Relationship Between Communication Portions of Bottom and Communication Portions of Lid

The communication portions 23a of the bottom 23 and the communication portions 24a of the lid 24 are configured such that the flow resistance to fluid passing through the lid 24 is lower than the flow resistance to fluid passing through the bottom 23. With this configuration, as will be described later, any leaked hydrogen is guided upward, and therefore the hydrogen disperses less in the horizontal direction and is discharged upward from the housing 21 to the atmosphere. The flow resistances can be compared by the difference in pressure before and after the fluid passes through the bottom 23 or the lid 24, namely the magnitude of pressure loss. Although the difference in flow resistance is not particularly limited, it is preferable that the difference in flow resistance be 5% or more and 70% or less.

Specific means for providing such a difference in flow resistance is not particularly limited. In this form, however, as long as the bottom 23 and the lid 24 have the same thickness, the difference in flow resistance can be provided by the difference in aperture ratio between the holes 23a and the holes 24a that are the communication portions. For the bottom 23, the aperture ratio is the ratio of the total area of the holes 23a (communication portions 23a) to the area surrounded by the outer edge of the bottom 23 (length (y) x width (x) in the case where the bottom 23 is rectangular). For example, the aperture ratio of the bottom 23 is 10% or more and 50% or less, the aperture ratio of the lid 24 is 30% or more and 70% or less, and the aperture ratio of the lid 24 is higher than the aperture ratio of the bottom 23. When the bottom 23 and the lid 24 have the same aperture ratio, the difference in flow resistance can be provided by making the thickness of the bottom 23 and the thickness of the lid 24 different from each other. The bottom 23 and the lid 24 may be different in both thickness and aperture ratio.

Form of Communication Portions

The shape of the communication portions of the bottom 23 and the shape of the communication portions of the lid 24 are not particularly limited and can be designed as appropriate. The first form illustrates an example in which the communication portions 23a of the bottom 23 and the communication portions 24a of the lid 24 are openings that are numerous holes in perforated metals. However, the form of the communication portions is not limited to this and can be designed as appropriate. Other forms of the communication portions will be described.

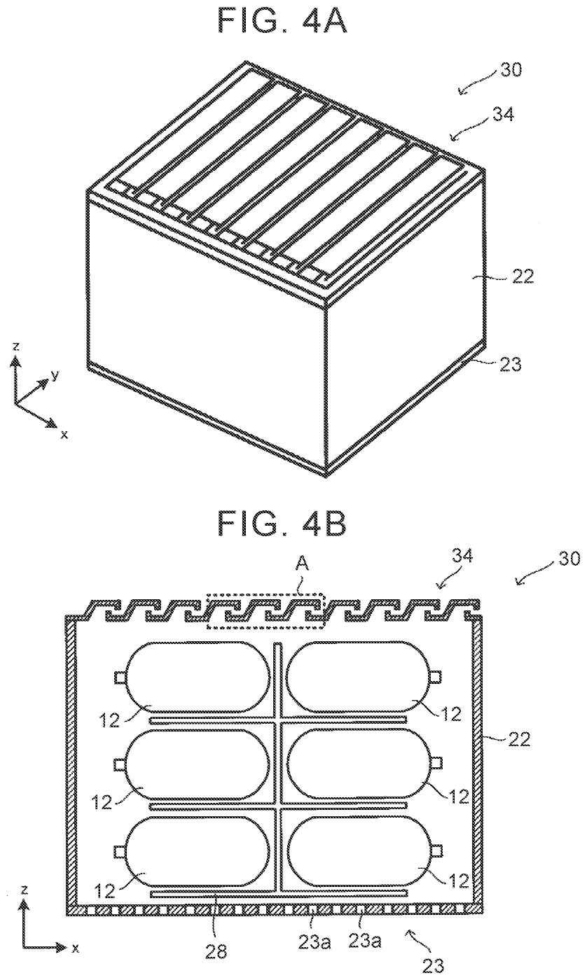

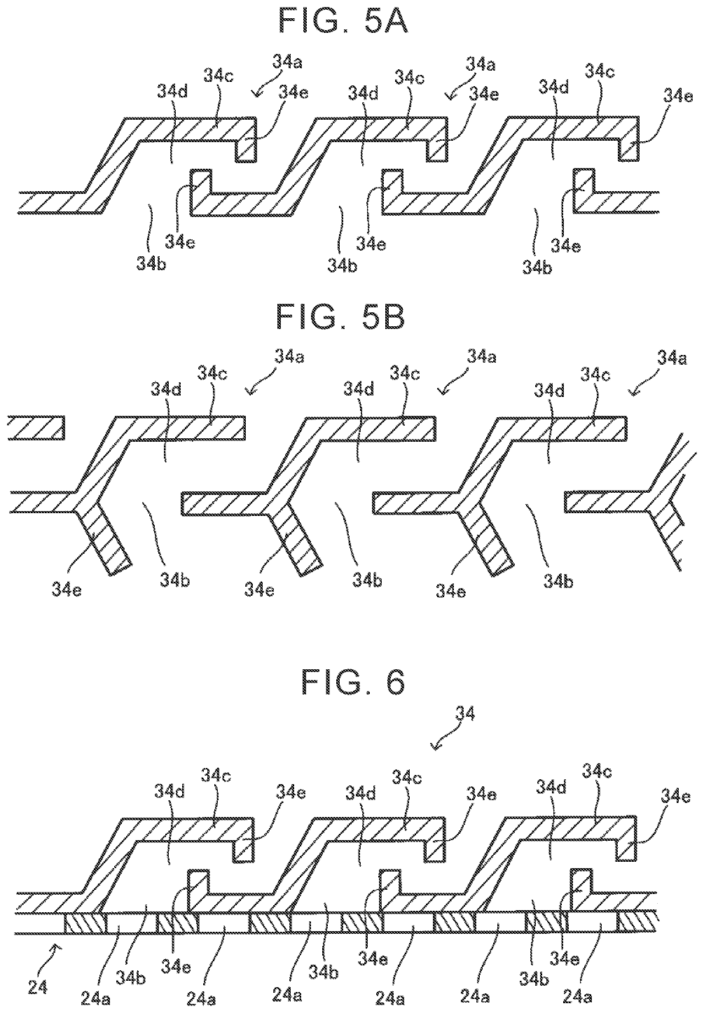

FIG. 4A is an external perspective view of a hydrogen tank storage case 30 according to a second form as viewed from the lid 34 side. FIG. 4B is a sectional view of the hydrogen tank storage case 30 taken along a plane parallel to an xz plane, illustrating how the hydrogen tanks 12 are arranged in the hydrogen tank storage case 30. FIG. 5A is an enlarged view of a portion A in FIG. 4B. In the hydrogen tank storage case 30 of this form, a lid 34 is used instead of the lid 24 of the hydrogen tank storage case 20. The hydrogen tank storage case 30 is otherwise the same as the hydrogen tank storage case 20. Accordingly, only the lid 34 will be described below. The other portions of the hydrogen tank storage case 30 are denoted with the same signs as those of the hydrogen tank storage case 20 and description thereof will be omitted.

The lid 34 has a plurality of slit-like openings 34b extending in the y direction and located next to each other in the x direction. The lid 34 also has pieces 34c covering the openings 34b from above. The openings 34b are thus hidden as the hydrogen tank storage case 30 is viewed in plan (as the hydrogen tank storage case 30 is viewed from above). This configuration reduces direct entry of rainwater into the housing and exposure of the inside of the housing to direct sunlight and thus increases durability of the hydrogen tanks and pipes disposed in the housing. The pieces 34c also form flow paths 34d leading to the outside through the openings 34b. The flow resistance of the lid 34 is therefore determined by the thickness of the lid 34, the opening area of the openings 34b, and the form of the flow paths 34d. In this form, a communication portion 34a is formed by the opening 34b and the flow path 34d.

The flow resistance of the lid 34 can be adjusted by the form of the flow paths 34d. For example, the flow resistance can be adjusted by the shape of the pieces 34c and pieces 34e shown in FIG. 5A (protrusions formed along the edges of the openings 34b or the edges of the pieces 34c). FIG. 5B shows another form of the pieces 34e. The pieces 34e shown in the example of FIG. 5B are pieces formed along the edge of the opening 34b and extending toward the inside of the housing 21.

According to the communication portions with such slit-like openings, the flow resistance can be easily adjusted by the shape of the communication portions. More hydrogen can therefore be discharged from the lid side, and dispersion of hydrogen in the horizontal direction can be reduced.

As shown in FIG. 6, the lid may be formed by placing the lid 34 included in the second form on top of the lid 24 included in the first form.

Material of Housing 21

It is preferable that the material of the housing 21 have high strength and high weather resistance from the standpoint that the hydrogen tanks are stored in the housing 21 and the standpoint that the housing 21 is loaded on a moving object and the environment in which the housing 21 is placed is likely to change significantly. From these standpoints, the housing 21 is preferably made of metal, and more specifically, is preferably made of an iron-based material such as stainless steel.

Others

Although the communication portions 34a are described above as a form of the communication portions of the lid, the above description is not intended to hinder this structure from being used for the bottom. The communication portions of the bottom may also be in the form described above on condition that the flow resistances of the lid and the bottom are as described above.

2.2. Tank Support

The tank support 28 shown in FIGS. 3A, 3B, etc. is a shelf-like member disposed inside the housing 21 and fixing and supporting the hydrogen tanks 12. The form of the tank support 28 is not particularly limited as long as the tank support 28 can stably hold the hydrogen tanks 12 in the housing 21, and a known tank support can be used.

3. Effects Etc.

According to the hydrogen tank storage case described above, even when hydrogen leaks from any of the hydrogen tanks 12 stored in the housing 21, the leaked hydrogen can be efficiently discharged upward through the lid 24 and the lid 34, and dispersion of the hydrogen in the horizontal direction can be reduced. That is, even when hydrogen should leak from two or more of the hydrogen tanks at the same time, the leaked hydrogen would not spew out of the housing through the side wall, and most of the leaked hydrogen would flow out of the housing through the lid. Accordingly, the pressure in the housing is immediately released. Moreover, since there is almost no propulsive force for the hydrogen to move in the horizontal direction, the reaching distance of the hydrogen in the flammable range in the horizontal direction of the moving object can be significantly reduced. Since the reaching distance of the hydrogen in the horizontal direction can be significantly reduced, the safety distance can be reduced and a higher level of safety can be ensured. A device that requires power is not necessary in order to control such discharge of the hydrogen, and hydrogen can be reliably discharged.

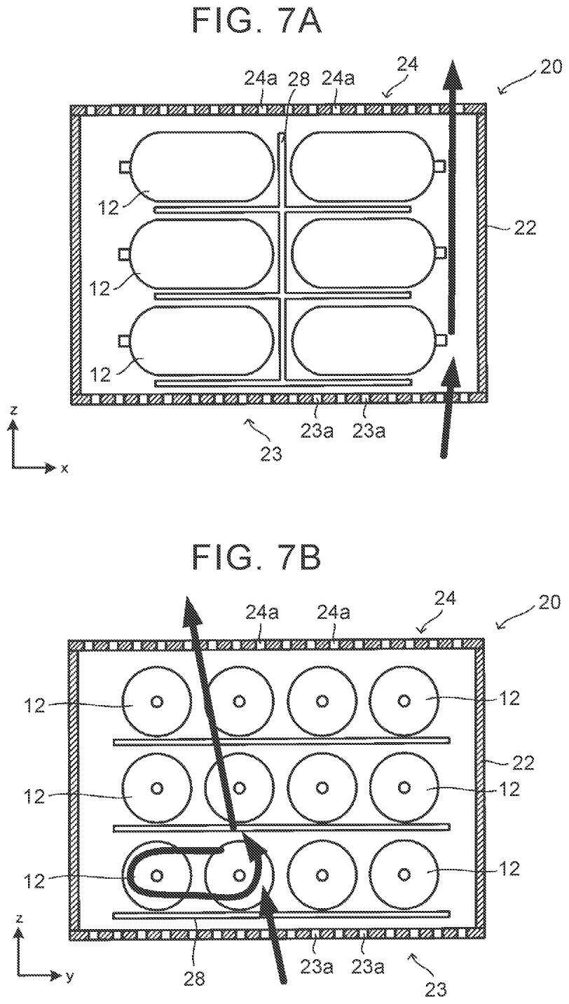

FIGS. 7A and 7B illustrate the flow of leaked hydrogen. FIGS. 7A and 7B are illustrations as viewed from the same point as FIGS. 3A and 3B, respectively. Since the lid and the bottom have the communication portions as shown in FIGS. 7A and 7B, air is introduced into the housing through the communication portions of the bottom, forming a vortex flow in the housing. The momentum of leaked hydrogen decreases as the leaked hydrogen repeatedly circulates while hitting the side wall. The momentum further decreases as the introduced air and the leaked hydrogen are mixed. Since the flow resistance of the lid is lower than the flow resistance of the bottom, such a mixed gas moves toward the lid where pressure loss is small. Most of the hydrogen can thus be discharged upward from the housing through the lid, and the amount of hydrogen that is discharged from the housing so as to disperse in the horizontal direction can be significantly reduced. The safety distance can therefore be reduced.

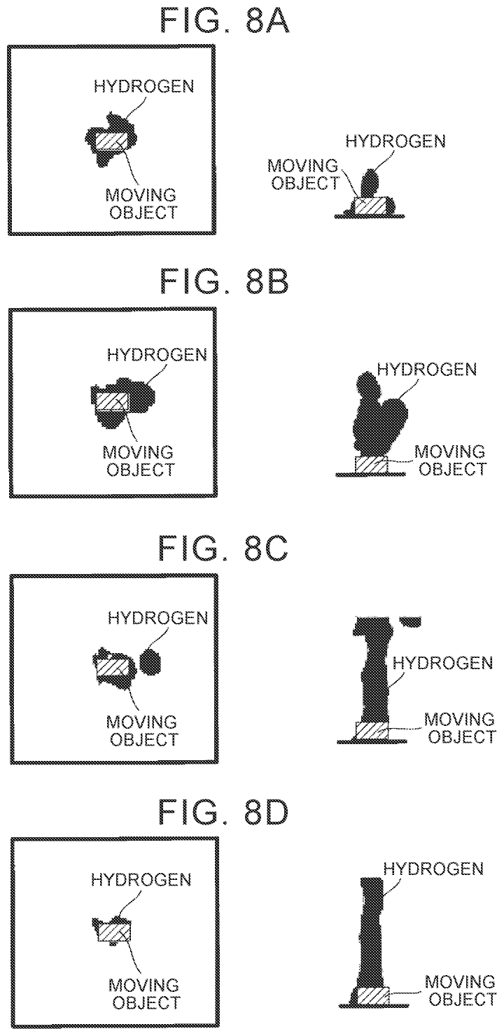

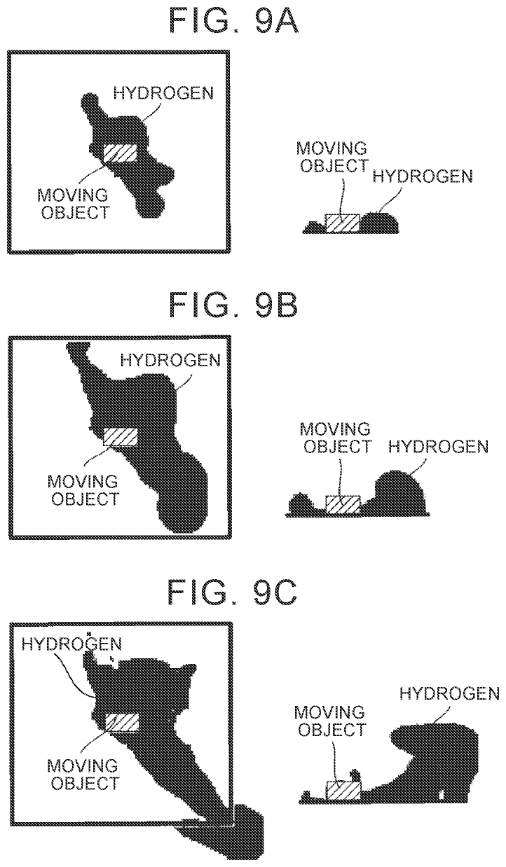

FIGS. 8A to 8D and FIGS. 9A to 9C illustrate the simulation results of dispersion of hydrogen gas discharged from the moving object. FIGS. 8A to 8D illustrate an example in which the aperture ratios of the lid and the bottom of the hydrogen tank storage case were 50% and 30%, respectively, and FIGS. 9A to 9C illustrate an example in which the aperture ratios of the lid and the bottom of the hydrogen tank storage case were 0% (that is, the lid has no communication portions) and 30%, respectively. The simulation was carried out on the assumption that hydrogen leaked from four hydrogen tanks in the housing at the same time. FIGS. 8A to 8D and FIGS. 9A to 9C illustrate dispersion of hydrogen with the passage of time. Specifically, hydrogen started leaking at zero seconds, FIGS. 8A and 9A illustrate dispersion after two seconds from the start of leakage, FIGS. 8B and 9B illustrate dispersion after five seconds from the start of leakage, FIG. 8C illustrates dispersion after nine seconds from the start of leakage, and FIGS. 8D and 9C illustrate dispersion after 11 seconds from the start of leakage. The illustration on the left side of each drawing is dispersion as viewed from above, and the frame is a 30 meters by 30 meters square frame centered on the moving object. The illustration on the right side of each figure is dispersion as viewed from the front (the same direction as in FIG. 1).

According to the results of the drawings, as shown in FIGS. 8A to 8D, in the case where both the lid and the bottom have openings and the flow resistance of the lid is lower than the flow resistance of the bottom, hydrogen does not disperse in the horizontal direction and moves upward. In this example, the maximum dispersion of hydrogen in the horizontal direction was six meters in FIG. 8C. As shown in FIGS. 9A to 9C, in the case where only the bottom has openings, hydrogen disperses significantly in the horizontal direction. In this example, the maximum dispersion of hydrogen in the horizontal direction was 20 meters in FIG. 9C. The reason for this is considered to be as follows. When a large amount of hydrogen flows out of the housing through the bottom, the hydrogen hits the ground hard immediately after it flows out of the housing as the ground is located immediately below the bottom of the housing. Accordingly, the hydrogen tends to disperse in the horizontal direction. Even with the lid having openings, a large amount of hydrogen will similarly flow out of the housing through the bottom to a greater or lesser extent and the hydrogen similarly tends to disperse in the horizontal direction, when the flow resistance of the lid is equal to or higher than the flow resistance of the bottom.

What is claimed is:

1. A hydrogen tank storage case that stores a hydrogen tank and that is loaded on a moving object, comprising
a housing having a box shape and having a side wall, a bottom, and a lid, wherein:
the bottom and the lid have a communication portion configured to allow communication between inside and outside of the housing; and
a flow resistance of the lid is lower than a flow resistance of the bottom.

2. The hydrogen tank storage case according to claim 1, wherein at least one of the bottom and the lid includes a perforated metal, and the communication portion is composed of a hole of the perforated metal.

3. The hydrogen tank storage case according to claim 1, wherein the communication portion is a slit.

4. The hydrogen tank storage case according to claim 1, wherein at least one of the bottom and the lid includes a perforated metal and has a hole, and further has a slit.
